(19) United States
(12) Patent Application Publication
(10) Pub. No.: US 2025/0391304 A1
(43) Pub. Date: Dec. 25, 2025

(54) SYSTEM AND METHOD FOR GENERATING IMAGE DATA FOR DISPLAY

(71) Applicant: Arm Limited, Cambridge (GB)

(72) Inventors: Fufu Fang, Cambridge (GB); Brendan James Moran, Coton (GB); Maxim Novikov, Sale (GB)

(73) Assignee: Arm Limited, Cambridge (GB)

(21) Appl. No.: 19/246,370

(22) Filed: Jun. 23, 2025

(30) Foreign Application Priority Data
Jun. 25, 2024 (GB) 2409083.9

(51) Int. Cl. G09G 3/20

(52) U.S. Cl. CPC G09G 3/2003; G09G 2320/0646; G09G 2320/0666; G09G 2354/00

(57) ABSTRACT

A system and method for generating image data at a data processing system, the method comprising: determining, at a first data processor unit, that an image comprising one or more inactive pixels is required to be displayed to meet one or more desired properties of the displayed image; providing first control data to cause the first or a further processor unit to generate image data which when displayed comprises the one or more inactive pixels.

The technology described herein relates to data processing systems, and in particular to processing units that provide image data for display.

Modern displays are often capable of displaying images. The properties of the displayed images can be controlled to affect how the image is viewed by a user, such as changing the brightness of the displayed image.

There exists the need to control the properties of displayed image(s) in an improved manner.

According to a first aspect of the present disclosure there is provided a method for generating image data at a data processing system comprising: determining, at a first data processor unit, that an image comprising one or more inactive pixels is required to be displayed to meet one or more desired properties of the displayed image; providing first control data configured to cause the first or a further processor unit to generate image data which when displayed comprises the one or more inactive pixels.

According to a further aspect of the present disclosure there is provided a computer readable storage medium storing computer software code which when executing on a processor performs the above method.
According to a further aspect of the present disclosure there is provided a data processor system to provide image data for display, the data processor system operable to: determine that an image comprising one or more inactive pixels is required to be displayed to meet one or more desired properties of the displayed image; providing first control data configured to cause a processor unit to generate image data, which when displayed comprises the one or more inactive pixels.

Various embodiments using the present techniques will now be described by way of example only and with reference to the accompanying drawings in which:

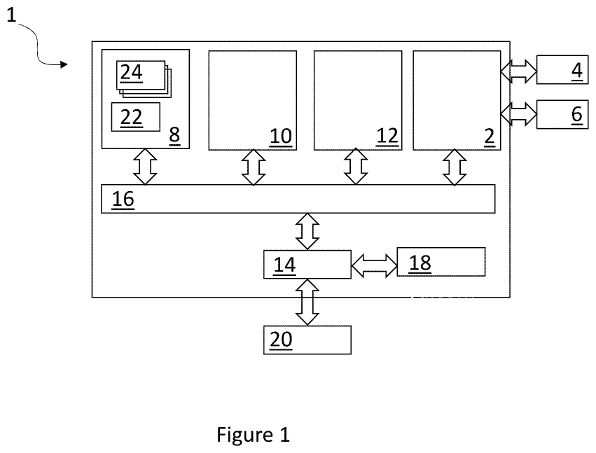

FIG. 1 shows an example data processing system;

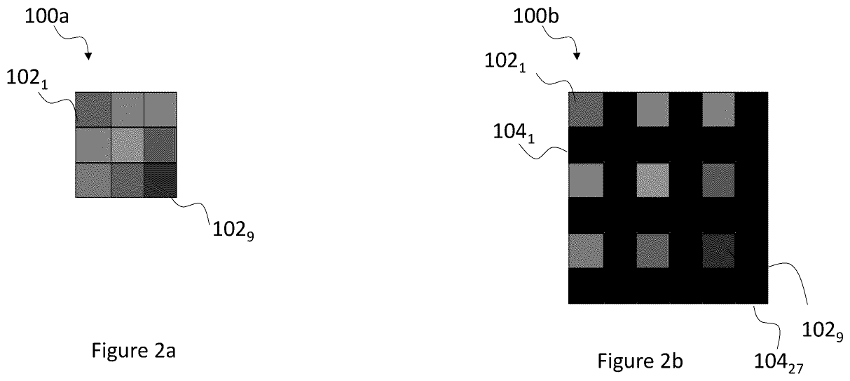

FIG. 2a illustratively shows an example of an image for display;

FIG. 2b illustratively shows an example of a modified version of the image of FIG. 2a having inactive pixels in accordance with the present techniques;

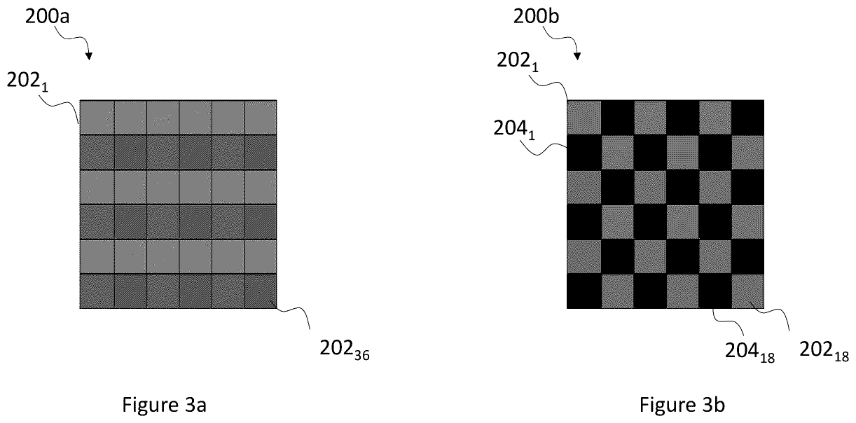

FIG. 3a illustratively shows an example of an image for display;

FIG. 3b illustratively shows an example of a modified version of the image of FIG. 3a having inactive pixels in accordance with the present techniques;

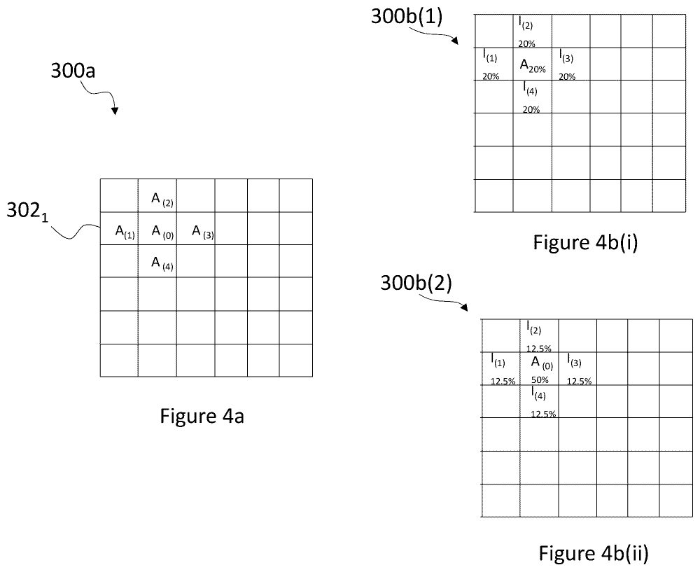

FIG. 4a shows image data which when displayed comprises a plurality of active pixels;

FIG. 4b(i) illustratively shows an example of a first modified version of the image data of FIG. 4a, which, when displayed, comprises, inactive pixels in accordance with the present techniques;

FIG. 4b(ii) illustratively shows an example of a second modified version of the image data of FIG. 4a, which, when displayed, comprises, inactive pixels in accordance with the present techniques;

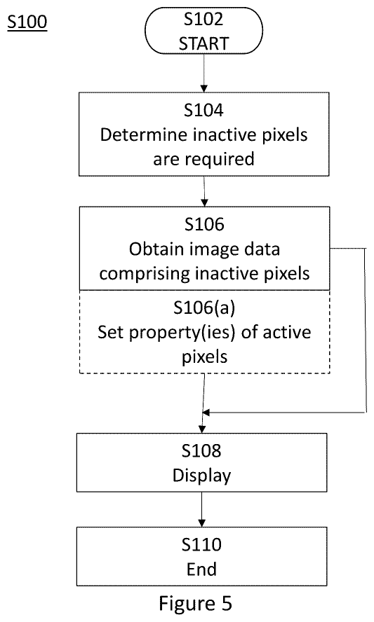

FIG. 5 shows a flow diagram of the operation of a data processing system to generate image data according to an implementation of the present techniques; and

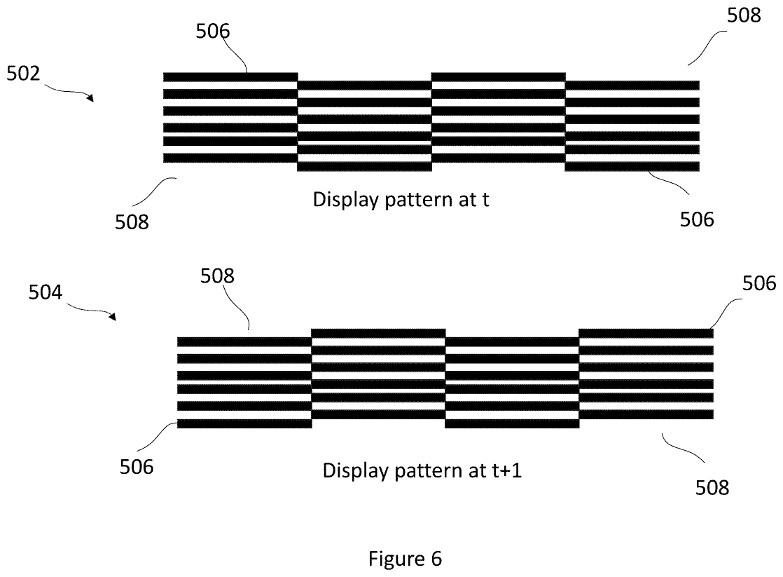

FIG. 6 illustratively shows patterns of pixels in storage in accordance with the present techniques.

Details of methods, apparatus, and processors according to examples will become apparent from the following description, with reference to the Figures. In this description, for the purpose of explanation, numerous specific details of certain examples are set forth. Reference in the specification to ‘an example’ or similar language means that a particular feature, structure, or characteristic described in connection with the example is included in at least that one example, but not necessarily in other examples. It should further be noted that certain examples are described schematically with certain features omitted and/or necessarily simplified for ease of explanation and understanding of the concepts underlying the examples.

FIG. 1 shows an embodiment of a data processing system 1 that may be in the form of a system on-chip (SoC).

The data processing system 1 comprises various modules or units to generate image data (e.g. one or more frames) to be displayed on one or more displays 4, 6.

In the illustrative example of FIG. 1, the data processing system 1 comprises a host processor comprising a central processing unit (CPU) 8, graphics processing unit (GPU) 10, a compression/decompression unit (codec) 12, display controller 2, and a storage controller 14.

The units depicted in the data processing system 1 of FIG. 1 are provided as examples only, and the data processing system 1 may have additional or alternative units to generate image data for display. As an illustrative example the data processing system 1 may comprise one or more of an image signal processor unit and video processor unit.

As shown in FIG. 1, the units may communicate via a system bus or interconnect 16 and have access to on-chip storage 18 (e.g. Cache, SRAM etc.) and/or off-chip main storage 20 (e.g. DRAM). The display controller 2 may also have one or more interfaces to output image data to be displayed. The output image data may be displayed on a display 4, 6, where for example a display may be a digital screen (e.g. a television screen, a wearable device screen or mobile phone screen) or the surface of a substrate or medium (e.g. when projected by a projector or etched by a laser).

As illustratively shown in FIG. 1 the data processing system 1 may be part of a device (e.g. a laptop, a mobile phone, a wearable device, a virtual reality device or an augmented reality device) and may comprise a local display 4, which may, e.g., be a display panel of the device. Additionally, or alternatively, the data processing system may comprise an interface (e.g. an HDMI, MHL, or Display Port, MIPI DSI, etc., interface) to a second, external display 6 (which may, for example, be a HD TV or monitor or a projector screen). In an embodiment, the image data may comprise pixel data to control at least one property or characteristic (hereafter “property”) of individual pixels in an array of pixels (e.g. arranged in rows or columns) on a digital screen. The individual pixels of the array may be addressable, and where one or more property or characteristic (hereafter “property”) of individual pixels may be controlled responsive to the pixel data in the image data to display a desired image. Such a property may be a colour value or brightness/intensity value of a respective pixel. In a further embodiment, image data may comprise pixel data to control at least one property of individual pixels on the surface of a substrate (e.g. paper, glass, metal) or when etched (e.g. by a laser).

In an example embodiments, the image data for display may be generated, for example, by the CPU 8, GPU 10, codec 12, and/or display controller 2, and may be stored in storage 18, 20. The display controller 2 may then access (read) the image data in storage 18, 20 to display an image at one or more display 4, 6, where the image is displayed responsive to the image data.

To facilitate this, the host processor should, and in an embodiment does, also execute a driver for the graphics processing unit and a compiler or compilers for compiling shader programs to be executed by programmable shading stages of the graphics processing unit (which compiler may be, and in an embodiment is, a part of the driver).

Thus, in an embodiment, the graphics processing unit is in communication with a host processor (that is part of the overall graphics processing system) that executes a driver for the graphics processing unit and/or a compiler or compilers for the graphics processing unit.

Similarly, in an embodiment, an application on the host processor may indicate (e.g. via control data comprising one or more instructions or commands) a requirement for performing processing operations in the manner of the technology described herein, which requirement is then recognised by, e.g., the driver executing on, the host processor, with the, e.g. driver on, the host processor then operating to instruct (e.g. using control data) the graphics processing unit to generate data in accordance accordingly.

In an embodiment, the CPU 8 may execute, inter alia, software 22 (e.g. a driver) for providing control data(s) (e.g. display controller instruction data) to the display controller 2 to control and configure the display controller 2 to provide the image data for display. The driver 22 may generate the control data in response to commands received from one or more application(s) 24 executing on the CPU 8 that require a particular image to be displayed on the display 4, 6.

In operation the display controller 2 can read image data to be displayed from storage 18, 20, where the image data to be displayed may be stored as a data array in storage 18, 20 (e.g. a “frame buffer”). Additionally or alternatively, the display controller 2 can receive image data for display from one or more of the units (e.g. CPU 8/GPU 10/Codec 12).

The display controller 2 can then provide the image data to the display(s) 4, 6 (e.g. via a pixel pipeline), where the image is displayed responsive to the image data. For an image comprising a series of frames (e.g. in a video game, a tv show or a movie) the process may be performed for each frame that needs to be displayed in accordance with a desired refresh rate e.g. at a rate of, for example, 30 or 60 frames per second.

The display controller 2 may process the image data read from the storage 18, 20 or received from one or more units prior to being displayed. This processing, which may be performed responsive to one more command instructions in the control data, may include display timing functionality (e.g. where it is configured to send pixel data to the display with appropriate horizontal and vertical blanking periods) to allow the image to be displayed on the display correctly at the correct time with the correct pixel properties for the individual pixels.

In a further example embodiment, the host processor 8 may execute application(s) 24 that can require graphics processing by the GPU 10, and send appropriate control data to the GPU 10 to control it to perform graphics processing operations and to produce graphics processing (render) output (e.g. image data) required by application(s) 24 executing on the host processor (including in the manner of the technology described herein). Thus, an application 24 executing on the CPU 8 may provide control data (e.g. GPU instruction data) to a rendering command stream for the GPU 10, which may cause the GPU 10 to render image data (e.g. one or more frames) for display based on or in response to the control data.

The GPU 10 can include, and in embodiments does include, any one or more, and in embodiments all, of the processing stages of a typical GPU. Thus, for example, in an illustrative embodiment the GPU 10 may include a primitive setup stage, a programmable execution unit operable to execute (shader) programs to perform processing operations, a rasteriser and a renderer (wherein the rendering approach may include, for example, raytracing, hybrid raytracing, or any other suitable rendering approach). In embodiments the renderer may be in the form of, or includes a programmable fragment shader. The GPU 10 may otherwise be configured and operable as desired, and be operable to execute any suitable and desired form of graphics processing pipeline (in its normal graphics processing operation). GPUs and graphics processing are well known in the art and as such will not be described herein in detail. The GPU 10 may for example, be a tile-based graphics processing unit comprising a tile buffer for storing tile sample values and/or a write out unit that operates to write the data in the tile buffer (e.g. once the data in the tile buffer is complete) out as image data to storage 18/20 (e.g. to a frame buffer) to be accessed, for example, by the display controller 2.

In embodiments of the method, the application(s) 24 and/or the driver 22 executing on the host processor may generate the command instructions and write the command instructions to a memory. In one or more embodiments, the GPU may include a Command Stream Frontend (CSF). The CSF may configure and/or control the operation of the GPU and to indicate a location in memory that received instruction(s) and/or command(s) reside in a memory associated with the GPU, wherein the CSF may be controlled directly by the host processor (CPU). In embodiments, the CSF includes a hardware interface (HWIF) which, once the GPU is configured, can fetch the instructions and/or commands from the memory to be executed. The CSF may, in embodiments, further include a Micro-Controller Unit (MCU), wherein the MCU of the CSF is a processor that executes software (preferably firmware). Accordingly, less complex CSF HWIF functions (e.g. instructions/commands) may be executed directly by the HWIF in hardware, whereas more complex CSF HWIF functions (e.g. instructions/commands) can be transmitted, or passed, by the CSF HWIF to the MCU to be executed in software, wherein the MCU may transmit appropriate jobs to other units (e.g. programmable executable units, memory, and so on) for execution.

Conventional graphics processing systems may include a CSF instruction set to execute graphics data processing, e.g. by the CSF HWIF in hardware and/or by CSF MCU in software (e.g. firmware) utilising the GPU units, e.g. programmable executable units (e.g. shader cores), to execute instructions/commands relating to the graphics pipeline.

The codec 12 may, in an encoding operation, compress data provided by the processing unit and write the compressed data to memory. Additionally, the codec 12 can, in a decoding operation, obtain compressed data (e.g. read the compressed data from memory or receive it from the CPU 8), decompress the compressed data, optionally process the data and provide decompressed data to a processing unit (e.g. CPU, GPU or display controller) for further processing or store the decompressed data in storage 18, 20.

The operation of the codec 12 may be controlled responsive to one or more control data (e.g. codec instruction data) from one or more the units (e.g. CPU, GPU, display controller etc.). For example, the one or more units can indicate to the codec 12 properties of decompressed data that the codec is to produce, such as data representation parameters and/or properties, such as RGB/RGBA/YUV values, number of components, number of bits (per component), floating point/unsigned/signed integers, etc.

The codec 12 can be any suitable coder/decoder unit that can compress and decompress data in an encoding/decoding operation. The codec may comprise an encoder and decoder circuit configured to compress and decompress data. The encoder and decoder circuit may comprise separate circuits, or may be at least partially formed of shared processing circuits. The codec 12 may be configured to compress and decompress data in accordance with a suitable encoding scheme (or schemes). For example, the encoding scheme implemented by the codec may be lossless or lossy, as suitable and desired. Such an encoding scheme may, for example, comprise block compression (BC), Adaptive Scalable Texture Compression (ASTC), PowerVR texture compression (PVRTC), AOMedia Video 1 (AV1) or any suitable format. In embodiments, a processing unit (e.g. CPU or GPU) can indicate to the codec, via codec instruction data the decoding/encoding scheme and/or options that the codec 12 should use when processing data.

In embodiments, the data processing system 1 may, via one or more communications channels (e.g. via the internet) receive an encoded (compressed) video stream representative and, responsive to, for example, one or more command(s) in the codec instruction data decode the video stream to generate the image data for display. The decoded image data may be stored to be accessed by another unit, or may be provided directly to a further unit (e.g. CPU, GPU, display controller) for further processing or display.

Thus, image data for display can be generated as desired. For example, the image data may be generated by being appropriately rendered (e.g. by a GPU) and stored into storage 18/20 by GPU 2. Additionally or alternatively, the image data may be generated by being appropriately decoded and stored into storage 18/20 by codec 12. Additionally or alternatively, image data for display may be generated by an image signal processor (ISP), or other image processor. The image data for display may be, e.g., for a game, a demo, a graphical user interface (GUI), a GUI with video data (e.g. a video frame with graphics “play back” and “pause” icons), etc.

One or more properties of a displayed image may be controlled responsive to user inputs or as required by an application. For example, known displays may include brightness or intensity (hereafter “brightness”) control, the brightness of a screen can be reduced as required by an application (e.g. auto-brightness functionality) or by a user (e.g. by adjusting hardware/software settings). However, such brightness control is typically achieved by changing the brightness of each individual pixel in an image, and there is generally an operational limit on how dim a display can be made, which minimum level may be set by a manufacturer (e.g. in firmware) to prevent colour accuracy being affected (e.g. colours may appear washed out at low light levels) or to prevent visibility issues (e.g. to prevent content becoming difficult to see). As a further example, PWM (Pulse-Width-Modulation) can be used to reduce brightness, but can result in flickering. While generally not very noticeable, techniques that reduce or avoid flicker are preferable.

In other examples, image data may be rendered (e.g. by a GPU) or modified (e.g. by a CPU) to provide image data which when displayed is displayed at a resolution supported by a display. In an illustrative example, first image data (e.g. stored in a frame buffer) may be modified responsive to one or more resolution downsampling algorithms to provide second image data, where an image displayed responsive to the second image data has a lower resolution than an image displayed responsive to the first image data. Alternatively, the GPU can render image data (e.g. responsive to control data from a host processor), which when displayed, has a resolution supported by a particular display.

The Applicant has identified techniques to control the properties of a displayed image(s) in an improved manner, where the present techniques comprise providing inactive pixels in at least a portion of a displayed image to meet one or more desired properties of the displayed image. For example, inactive pixels may be provided in a displayed image to reduce the brightness of (at least a portion of) the displayed image, to reduce the resolution of (at least a portion of) the displayed image and/or to reduce the processing/power burden on a data processing system when generating image data/displaying an image.

As an illustrative embodiment, a sensor (not shown) may be arranged to detect the level of light in the environment in which a display 4/6 is located. The sensor may be operable to detect the brightness of light (e.g. ambient light) in the environment in which the display 4, 6 is located and generate sensor data (e.g. measurements for the levels of light) provided for processing at the data processing system. The displayed image may be provided with inactive pixels to meet one or more desired properties of the displayed image in accordance with the sensor readings. For example, in low-light conditions, a user may desire to use a reduced-brightness setting on the display. Rather than solely reducing the brightness of each pixel, which could take the pixels out of a preferred operating window or below a minimum brightness level, instead certain pixels may be controlled to be inactive pixels to achieve the lower brightness.

As a further illustrative example, a user may wish to operate the display at a reduced brightness level. Once the brightness reaches a preferred operating range or the minimum supported brightness, additional dimming may be achieved by selectively rendering certain pixels inactive. This approach, described in more detail below with reference to FIGS. 2-5, enables further brightness reduction beyond the panel's conventional minimum without compromising colour accuracy or introducing common issues associated with traditional dimming techniques such as pulse-width modulation (PWM), including flickering or washed-out colours. By leveraging inactive pixels, the system maintains visual quality while overcoming the limitations of standard brightness controls. In a further illustrative example, a sensor (e.g. a camera) may detect a position on the display at which a user's gaze is fixed (i.e. where the user is looking) and the sensor data (e.g. positional data) provided for processing at the data processing system. The sensor readings may be processed at the data processing system, and inactive pixels added to the displayed image to meet one or more desired properties of the displayed image in accordance with the sensor readings. Thus the control data may be used to control the properties (e.g. number, pattern) of the inactive pixels responsive to the position at which a user is, or is not, looking. For example, inactive pixels may be added to portions of the displayed image at which the user is not looking at and hence less likely to notice.

In other embodiments, the properties or characteristics of an image to be displayed may be determined responsive to instruction data generated by an application running at a processor unit (e.g. CPU or GPU). As an illustrative example, an application (e.g. at CPU or GPU) may, prior to rendering an image, determine the amount of light that would be in the image (or in a portion of an image) due to be rendered (e.g. by CPU or GPU)). The application may then instruct the GPU 10 (e.g. using control data) to render the image to have inactive pixels in at least a portion thereof to meet one or more desired properties of the displayed image (e.g. to prevent washout due to a dark portion in an image to be displayed). Further, rendering inactive pixels reduces the processing needing to be performed by the GPU. This in turn can reduce the power consumed by the GPU.

As a further illustrative example, when it is determined that the power capabilities of the data processing system are below a threshold (e.g. when it is determined that a battery level is below a threshold level, or the data processing system is powered by a battery source vs a regulated power source (e.g. mains power)), then rather than displaying all portions of the displayed image at a high resolution, the present techniques may be used to cause inactive pixels to be provided in one or more portions of the displayed image to reduce the resolution of those portions of the displayed image and, in turn, reduce the processing and power requirements when displaying the image. Such functionality may be useful to achieve power saving. Such functionality may also be useful for “always-on” displays, for example, when powered by a battery source.

FIG. 2a illustratively shows an example of a first image for display 100a, the first image having active pixels 102₁₋ₙ (where n=9 in FIG. 2a). FIG. 2b illustratively shows a second image for display 100b which is a modified version of the first image 100a, where the second image 100b includes inactive pixels 104₁₋ₘ (where m=27 in FIG. 2b) in accordance with the present techniques. It will be appreciated that the images 100a/100b are for illustrative purposes only, and may be considered to be a sub-portion of an image that is displayed which may, in operation, comprise tens/hundreds/thousands of thousand pixels.

In the illustrative example, three rows and three columns of inactive pixels are added to the image 100a, although any pattern or number of inactive pixels may be provided. The resulting image for display 110b having the active pixels will, when displayed, be a sparse representation of the image data for display 110a.

The resulting second image 110b when displayed will, as a result of the inactive pixels, provides for reduced brightness compared to original image 100a. For example, in FIG. 2b, the second image 110b, when displayed, will be displayed at 25% of the minimum brightness that the display panel supports, as 75% of the total pixels on the panel will be inactive.

Thus, adding inactive pixels provides a way to control (decrease) the brightness of a portion of a displayed image in addition to, or as an alternative to, controlling the brightness of individual pixels in that portion. Such functionality provides a way to decrease the brightness of a displayed image in addition to or as an alternative to reducing the brightness of individual active pixels using known techniques. Such functionality may be useful for a display screen having a minimum level of brightness.

In embodiments, the inactive pixels may be added to the whole image, or to one or more sub-portions of the overall displayed image.

Adding additional inactive pixels to an image may affect the quality of the resulting displayed image. For example, adding inactive pixels may reduce the resolution of the resulting displayed image. Thus, adding inactive pixels to an image to be displayed may provide a way to reduce or downsample the resolution of a displayed image to, for example, enable a display that supports lower resolutions to display an image that has its resolution downsampled.

As will be seen the second image 110b when displayed will, due to the additional rows and columns of inactive pixels, have an increased spatial area compared to the original first image 100a when displayed.

Thus, in an embodiment in accordance with the present techniques, inactive pixels may be provided in at least a portion of an image to be displayed without increasing the spatial area of the image.

FIG. 3a illustratively shows an example of an image for display 200a, the image 200a having active pixels 202₁₋ₙ (where n=36 in FIG. 3a). In accordance with the present techniques, FIG. 3b illustratively shows image 200b which is a modified version of the image 200a, the image 200b having active pixels 202₁₋₁₈ along with inactive pixels 204₁₋ₘ (where m=18 in FIG. 3b) provided therein in accordance with the present techniques. By making active pixels of image 200a inactive, the resulting image 200b having inactive pixels 204₁₋₁₈ may have (substantially) the same spatial area as the image 200a.

The image 200b comprises a checkerboard pattern of inactive pixels 204₁₋ₘ provided between every other active pixel 202₁₋₁₈ along each row and column in the array. Thus, the image 200b, when displayed, will be displayed at 50% of the minimum brightness that the display panel supports, as 50% of the total pixels on the panel are inactive.

It will be appreciated that the claims are not limited in respect of the patterns of inactive pixels depicted in FIG. 2b or 3b and any pattern or number of inactive pixels may be provided as required to meet one or more desired properties of the displayed image. For example, the pattern along each row and/or column in an array may comprise two or more consecutive inactive pixels between each active pixel. In embodiments the properties of the pixel data in the image data may be adjusted to cause an active pixel to become inactive. In other examples, a filter (e.g. low pass filter) may be applied to previously generated image data or a mask may be applied to the previously generated image data. In other embodiments the image data may be rendered to include inactive pixels (e.g. where image data is generated by a GPU as opposed to processing an existing image in storage to add inactive pixels to the existing image).

Providing inactive pixels in an image to be displayed may result in artefacts on the displayed image, thereby resulting in reduced visual quality for a user viewing the image on the display. Thus, in an embodiment in accordance with the present techniques, one or more mitigation techniques may be applied to mitigate any impact adding such inactive pixels to an image to be displayed may have.

As an illustrative example of such mitigation techniques, FIG. 4a illustratively shows image data 300a which when displayed comprises active pixels A₀ to A₄. The image data 300a is modified to provide image data 300b(1) and 300b(2), where pixels A₁ to A₄ depicted in FIG. 4a are controlled to be inactive pixels I₁ to I₄ in FIGS. 4b(i) and 4b(ii).

Rather than simply modify the active pixels to be inactive, an example mitigation technique includes modifying one or more properties of the active pixel A₀ to mitigate any impact providing inactive pixels to the image data may have, for example, on the user experience.

Looking again at FIG. 4a, the active pixels in a displayed image resulting from the first image data 300a will each contribute to the actual colour as perceived by the user, and any contribution of the colour may be lost when the active pixels become inactive pixels which, in turn, may affect the quality of the resulting image.

In an illustrative example of a mitigation technique, an average of the pixel colour value of each active pixel A₀ to A₄ in the image data of FIG. 4a is computed, and the properties of the active pixel A₀ in FIGS. 4b(i) and 4b(ii) are modified such that the previously active, and now inactive, neighbouring pixels I₁ to I₄, also contribute to the colour of the active pixel A₀. Thus, the active pixel A₀ effectively interpolates the colour that should have been displayed by the active pixel and it's neighbouring now inactive pixels. Such functionality may be applied to some or all of the remaining active pixels.

In some examples, and as illustratively shown in FIG. 4b(i), the colour of the active pixel may comprise an equal allocation or contribution of the average colour values of the active pixel A₀ and one or more of the inactive neighbouring pixels. Thus, in FIG. 4b(i), the pixel A₀ comprises a 20% contribution from itself and each of the neighbouring now inactive pixels I₁ to I₄.

In some examples, and as illustratively shown in FIG. 4b(ii), the colour of the active pixel may comprise an unequal allocation or contribution of the average colour values of the active pixel A₀ (i.e. itself) and the one or more of the inactive neighbouring pixels. Thus, in FIG. 4b(ii), the pixel A₀ comprises a 50% contribution from itself and 12.5% from each of the neighbouring inactive pixels I₁ to I₄.

In the embodiments depicted in FIGS. 4a and 4b, the same contribution percentage is allocated to each of the neighbouring inactive pixels (20% in FIG. 4a & 12.5% in FIG. 4b) but the claims are not limited in this regard and each of the now inactive neighbouring pixels may each provide an unequal contribution.

In the embodiments depicted in FIGS. 4a and 4b, the contribution is from the cruciform neighbours. However, it will be appreciated that the claims are not limited in this regard, and the contribution may be from any one or more of the neighbour pixels. Furthermore, the contribution is not limited to adjacent neighbours.

Whilst the example above in FIGS. 4a and 4b describe modifying the properties of active pixels in a first image to take account of properties (e.g. colour values) of neighbouring active pixels in the first image that were made inactive in a second image, the claims are not limited in this respect. A processor unit rendering image data on the fly may also set the properties of active pixels to take account of any inactive pixels to mitigate any potential effects such inactive pixels may have. For example, a CPU or GPU may determine the properties the active pixels should have when rendering image data having inactive pixels to mitigate any reduction in visual quality resulting from the inactive pixels.

The present techniques are applicable for various applications across many different system configurations, where each system may have different capabilities or hardware/software.

For example, the present techniques may be used on a wearable device (e.g. a watch) or mobile device (e.g. mobile telephone) having a display. In such cases, a sensor may detect the brightness of a user's surroundings and responsive to the brightness levels being below a threshold, inactive pixels may be provided in an image displayed on the display. In embodiments, the properties or characteristics of a displayed image may change responsive to conditions or requirements. As an illustrative example the number of inactive pixels provided in a displayed image may increase as the brightness detected in an environment in which a display is located changes (e.g. decreases). Different patterns/numbers of inactive pixels may be added responsive to the level of brightness detected.

As a further illustrative example of mitigating the effect of artifacts on the displayed image, different patterns of inactive pixels can be applied to successive images (e.g. a first pattern of inactive pixels may be provided in a first frame (e.g. at time t), and a second pattern of inactive pixels may be provided in a second frame (e.g. at time t+1). Providing different patterns of inactive pixels may cause the user's eye to filter out any artefacts.

The present techniques of adding inactive pixels to meet one or more desired properties of the displayed image may be used to improve with existing graphics/image processing techniques.

As an illustrative example, the present techniques may be used in accordance with foveated rendering, which is a rendering technique where one part of an image displayed is displayed at a relatively high resolution and one or more other parts are displayed at lower resolution(s). Foveated rendering may be used to render the portion of the displayed image at which the user is looking directly (e.g. as detected by eye-tracker circuitry) at a higher resolution, while portions of the image in the user's peripheral vision may be rendered at a lower resolution while still appearing perceptually or visually acceptable. Thus, inactive pixels may be provided in the portions of the displayed image to reduce the resolution of those portions as required.

In a further illustrative example, in an application requiring rendering for high-speed frames per second (fps), the resolution of frames can be reduced by having the GPU render frames having inactive pixels in the frames. The rendering of frames to have inactive pixels can be controlled responsive to the GPU instruction data provided to a rendering command stream from an application running at the CPU. Such functionality of rendering inactive pixels in an image to be displayed may be used as an alternative to antialiasing and upscaling techniques, which may reduce processing power required to render the image data.

In a further illustrative example, the present techniques for rendering frames having inactive pixels may be used in addition to (or as an alternative to) variable rate shading (VRS). VRS (e.g. as defined in the DirectX and Vulkan specifications) is a technique that allows a trade-off between image quality and processing effort to be varied across a frame for display. For, example, when using VRS techniques, different portions of a frames can be rendered at different resolutions dependent on the scene to be displayed in an image where less important portions of a scene are rendered at lower resolution compared to more important portions of the scene, thereby reducing the processing effort for those pixels in the less important portions compared to the processing effort for those pixels in the more important portions. Thus a pattern of inactive pixels can be added to one or more portions of a rendered frame to meet one or more desired properties of the displayed image (e.g. to reduce a resolution or brightness dependent, for example, on the scene in the image displayed to a user). Furthermore, adding patterns of inactive pixels to a portion(s) of a rendered frame instead of applying VRS techniques in that portion(s) may also negate the need for upsampling and/or antialiasing techniques which may otherwise be required when using VRS techniques.

In a further illustrative example, the present techniques of adding inactive pixels can be used in addition to techniques that add sub-pixel jitter to a frame (e.g. a relatively low resolution frame). When rendering a frame, a GPU can use sub-pixel jitter techniques, where a pixel (jittered pixel) is not rendered in the same position for each rendered frame but is instead shifted in the frame by a small amount (e.g. ½ pixel).

Before displaying a rendered frame comprising a jittered pixel on a panel having greater resolution than the rendered frame, the rendered frame is required to be processed (e.g. by antialiasing, interpolation, averaging etc.) to take account of the jittered pixel to ensure it can be shown correctly on the display.

As an illustrative example, when using a display having 2× the resolution of a rendered frame having a jittered pixel, the rendered frame would generally require processing (e.g. interpolation, averaging etc.) to ensure it is displayed correctly on the panel. However, if the jittered pixel is determined to land at a position of a physical pixel on the display and its neighbouring pixels are not required, then the jittered pixel can be rendered in a frame along with a pattern of inactive pixels and there no requirement for the additional processing (e.g., antialiasing, interpolation or averaging) that would otherwise be required to take account of neighbouring pixels.

In a further illustrative example, the present techniques may be used with high dynamic range (HDR) techniques (e.g. HDR10/HDR10+/Dolby Vision etc.). Using HDR techniques when displaying an image, provides for a wider dynamic range of luminosity than is typically possible without using HDR techniques.

It will be seen that adding inactive pixels to the HDR image provides for additional control of properties or characteristics for the displayed image (or sub-portion(s) thereof) than would otherwise be achieved than HDR alone (e.g. for dim areas in the HDR image), and provides for the integrity of a displayed image to be maintained even at reduced levels of brightness compared to using HDR techniques alone.

In a further a further illustrative example, the present techniques can be combined with PWM control, where, instead of switching all pixels on and off multiple times per frame, different patterns of inactive pixels may be provided in the consecutive frames of a displayed image (e.g. with ½, or ¼ of the pixels in a frame of a displayed image being inactive pixels) thereby reducing the flicker. Such techniques to add different patterns of inactive pixels to different frames may be controlled by, for example, the display controller, or using hardware/software at the display itself.

As a further illustrative example, the displayed pattern may change at a faster rate than the frame rate/refresh rate of the displayed images. Such functionality may be achieved by, for example, the display receiving a new frame to be displayed every ˜ 1/60 of a second and then displaying each received frame until replaced by a newly received frame (i.e. the frame rate). Thus, in this illustrative example, the frame rate is 1/60 of a second.

In accordance with the present techniques, the display may (e.g. using hardware/software thereat) add a pattern of inactive pixels (e.g. stored in storage thereat) to the displayed frame at a rate that is faster than the frame rate. As an illustrative example the display may add alternating patterns of inactive pixels to a frame (e.g. at 1/120 of a second, 1/240 of a second etc.). Such functionality can be used to meet one or more desired properties of the displayed image (e.g. to control the brightness of the displayed image).

Thus the present techniques provide for adding one or more inactive pixels in the displayed image to meet one or more desired properties of the displayed image.

FIG. 5 is a flow diagram S100 for providing inactive pixels in image data according to one or more embodiments of the present disclosure.

At S102 the method starts.

At S104 it is determined that an image (e.g. one or more frames) is required to be displayed having one or more inactive pixels to meet one or more desired properties of the displayed image. The one or more desired property may be a desired brightness, resolution or a desired power saving.

Such a determination may be made for example, by a processor unit (e.g. a CPU, GPU or other unit), and may be responsive to a sensor reading(s) (e.g. a level of brightness, position of a user's gaze etc.) in an environment in which the image is to be displayed. In a further example, the determination may be responsive to an image in a scene that is to be displayed (e.g. as part of a game). In a further example, the determination may be made responsive to determining the capabilities of a display. In a further example, the determination may be responsive to instructions from a remote entity (e.g. a video streaming server). For example, a streaming service may provide instructions as to how inactive pixels should be added to images (e.g. video frames) displayed responsive to a video stream received at a data processing system.

At S106, responsive to the determination that an image is required to be displayed having one or more inactive pixels to meet one or more desired properties of the displayed image, an application at the processor unit may generate control data to cause the first processor unit or a further processor unit to obtain (e.g. generate) such image data. The resulting generated image data may be stored in storage (e.g. in a frame buffer) prior to display.

In an example embodiment, the image data may be generated (e.g. rendered) by a GPU responsive to control data from an application running on a host processor. The application on the host processor may require brightness control for the displayed image on a wearable or mobile device (e.g. a smart watch or mobile phone) when a certain level of brightness is detected in the environment in which the device is located (e.g. when the brightness is detected to be at or below a threshold brightness level). In a further illustrative example, an application may require providing inactive pixels in one or more displayed images of a game for a particular effect (e.g. to avoid washout in a scene) or as part of foveated rendering depending on where a user is looking, and instruct the GPU to render the image data accordingly.

In a further example embodiment, stored image data (e.g. a previously generated image) may be modified (e.g. by a CPU) to provide inactive pixels in the modified image to control a property thereof. For example, the CPU may require reducing the resolution of the previously generated image for display on a connected display that only supports lower resolution images. For example, the previously generated image may comprise 1920×1080 pixels, and where the CPU may modify the image data by adding inactive pixels such that the modified image data is displayed at a resolution supported by the display (e.g. 960×540 pixels).

In a further example embodiment, an encoded video stream comprising video image data (e.g. a plurality of frames) may be received at a data processing system (e.g. from a streaming server). The encoded video stream may be decoded (e.g. decompressed) (e.g. by a codec), and processed (e.g. by a CPU or GPU) to add inactive pixels. The inactive pixels may be added to the decoded video stream to take account of the properties or characteristics of, for example, the capabilities of the display on which the video stream is to be viewed (e.g. the supported resolution) or the environment (e.g. lighting levels) in which the video image data is to be viewed by a user. In another embodiment, the inactive pixels may be in image data in the decoded video stream (e.g. where the inactive pixels are added at the streaming server prior to sending to the data processing system that decodes the video stream).

The inactive pixels in the resulting image(s) displayed responsive to the image data may be provided across the whole of a displayed image, or may be provided at one or more portions of the displayed image(s) to meet one or more desired properties of the displayed image. Thus, inactive pixels may be provided in one or more relatively small portion(s) (i.e. a sub-portion) of the displayed image to control a property(ies) of the one or more sub-portion(s) of the image or the inactive pixels may be provided in the whole image to control a property(ies) of the whole image. Thus, it will be seen that providing inactive pixels allows for control of one or more properties of a whole image (global control) or for control of one or more properties of one or more sub-portions of an image (local control) displayed responsive to the image data. It will be appreciated that different patterns of inactive pixels may be provided in different sub-portions of the image to provide local control at different portions of the displayed image.

Optionally, at S106(a), one or more mitigation technique(s) may be applied to set one or more property(ies) of the active pixels to mitigate for any effects the provision of the inactive pixels may have.

In an embodiment, one or more colour values of the active pixels may be set to mitigate the effect of the inactive pixels in the displayed image. As an illustrative example, one or more properties of the active pixels in the image data to be displayed may modified to mitigate any impact providing the inactive pixels in the displayed image may have. In an example embodiment, one or more colour values of an active pixel (e.g. in different colour channels) may be adjusted to take account of any inactive pixels as described above.

At S108 a unit (e.g. display controller unit, CPU or GPU) at the data processing system causes an image having the inactive pixels to be displayed at a display to meet one or more desired properties of the displayed image.

At S110 the method ends.

Thus the present techniques provide for generating image data which when displayed (e.g. on a screen) comprises one or more inactive pixels to meet one or more desired properties of the displayed image.

As above, the claims are not limited in respect of the patterns of inactive pixels depicted in FIG. 2b or 3b and any pattern or number of inactive pixels may be provided as required to meet one or more desired properties of the displayed image.

In some embodiments the pattern may provide for improved data processing operations. For example, aligning the active pixels with how image data is read from storage may provide for efficient memory reads.

As an illustrative example, FIG. 6 shows display/read patterns 502, 504 within a rectangular frame in accordance with the present techniques. The image data relating to the active pixels in the patterns may be read from storage which may, for example, be dynamic random-access memory (DRAM), synchronous DRAM (SDRAM) (e.g. double data rate (DDR) SDRAM)) etc, although the claims are not limited in this respect and any suitable storage may be used.

Typically image data may be returned from storage (e.g. from a frame buffer) responsive to a read or fetch request (e.g. from a display controller). For example, single pixels 506, 508 in the image data may be returned on a per-pixel basis. However, such functionality is slow due to waiting for the data to be read/fetched via an interface (e.g. AXI)

Many communication interfaces such as the application extensible interface (AXI) provide functionality to obtain multiple data in single request. This is often referred to as “burst read”, which increases read speeds due to reduced number of transactions.

Burst reads typically require data to be contiguous in memory, therefore patterns of active pixels 506 (with corresponding inactive pixels depicted as 508) in alternating patterns 502, 504 are aligned in storage to provide an efficient read direction. For example, the image data relating to the active pixels 506 may be stored row-by-row in memory (i.e. aligned horizontally) and, when read, displayed as alternating patterns of active 506 and inactive pixels 508 as depicted by the patterns 502 and 504.

In the example where the data is aligned horizontally, reading the data relating to the active pixels in a vertical direction from storage would mean either a read request is needed for each active pixel in the subsequent (alternating) pattern to be displayed, or half (for example) of the data read would need to be discarded (which may also be faster than per-pixel requests). When the required stored data is aligned with efficient reads (horizontal in this example), then less reads are needed to fetch all pixels and if horizontal pattern size is aligned with burst size no data is required to be discarded. It will be appreciated that the efficiencies described above will depend on how the image data is aligned in storage—for example aligning data in a vertical direction would mean that reading data relating to active pixels in a vertical direction may be more efficient then reading data relating to active pixels in a horizontal direction.

Such functionality allows the display controller (for example) to adjust the memory reads from the frame buffer based on the pattern of inactive pixels required for a frame to be displayed.

Whilst the techniques above generally describe display of an image on a digital display or screen, the claims are not limited in this respect.

As a further illustrative example of where the present techniques may be applied, a laser may be used to melt, burn or vaporise material on the surface of a substrate and a laser display controller may be used to, responsive to image data, control the laser to focus a beam on the surface to etch or ablate an image on the surface. The image data may comprise inactive pixels (or areas), which may be defined in the image data such that the laser beam does not etch the area defined by the inactive pixels.

Such inactive pixels may be useful to control the brightness of the laser during the etching process, thereby avoiding burn on the surface of the substrate. The image data may be generated by a processor (e.g. a CPU) and provided to a display (laser) controller. The image data may add inactive pixels when taking account of the image to be displayed. For example, when the image to be displayed comprises continuous etching a particular area which is likely to result in burning of the surface, inactive pixels may be added to the image data in a pattern that avoids overheating a particular area. The properties of the surface to be etched (e.g. material type, reflectivity) and laser (e.g. power) may be taken into account when generating the image data.

The present techniques may be performed by hardware, software or a mix of the two. As an illustrative example, the techniques to provide an image having inactive pixels (e.g. to control the brightness of the resulting displayed image) may be performed using a host processor, a GPU, a display controller, an ISP, video processor responsive, for example, from instructions from an application running on a host processor.

The technology described herein can be implemented in any suitable system, such as a suitably configured micro-processor based system. In an embodiment, the technology described herein is implemented in a computer and/or micro-processor based system.

The technology described herein is, in an embodiment, implemented in a portable device, such as a mobile phone, tablet, smart glasses, head mount display and so on. The technology described herein is, in an embodiment, implemented in an HMD. Another embodiment of the technology described herein comprises a virtual reality, mixed reality, and/or augmented reality display device comprising or in communication with the processing system of any one or more of the embodiments of the technology described herein.

Correspondingly, another embodiment of the technology described herein comprises a method of operating a virtual reality and/or augmented reality display device, comprising operating the XR display device in the manner of any one or more of the embodiments of the technology described herein.

The various functions of the technology described herein can be carried out in any desired and suitable manner. For example, the functions of the technology described herein can be implemented in hardware or software, as desired. Thus, for example, unless otherwise indicated, the various functional elements, stages and “means” of the technology described herein may comprise a suitable processor or processors, controller or controllers, functional units, circuits, processing logic, microprocessor arrangements, etc., that are operable to perform the various functions, etc., such as appropriately dedicated hardware elements (processing circuit(s)) and/or programmable hardware elements (processing circuit(s)) that can be programmed to operate in the desired manner.

It should also be noted here that, as will be appreciated by those skilled in the art, the various functions, etc., of the technology described herein may be duplicated and/or carried out in parallel on a given processor. Equally, the various processing stages may share processing circuit(s), etc., if desired.

Furthermore, any one or more or all of the processing stages of the technology described herein may be embodied as processing stage circuit(s), e.g., in the form of one or more fixed-function units (hardware) (processing circuit(s)), and/or in the form of programmable processing circuit(s) that can be programmed to perform the desired operation. Equally, any one or more of the processing stages and processing stage circuit(s) of the technology described herein may be provided as a separate circuit element to any one or more of the other processing stages or processing stage circuit(s), and/or any one or more or all of the processing stages and processing stage circuit(s) may be at least partially formed of shared processing circuit(s).

Subject to any hardware necessary to carry out the specific functions discussed above, the components of the graphics processing system can otherwise include any one or more or all of the usual functional units, etc., that such components include.

The methods in accordance with the technology described herein may be implemented at least partially using software, e.g. computer programs. It will thus be seen that in further embodiments the technology described herein comprises computer software specifically adapted to carry out the methods described herein when installed on a data processor, a computer program element comprising computer software code portions for performing the methods described herein when the program element is run on a data processor, and a computer program comprising code adapted to perform all the steps of a method or of the methods described herein when the program is run on a data processing system. The data processor may be a microprocessor system, a programmable FPGA (field programmable gate array), etc.

The technology described herein also extends to a computer software carrier comprising such software which when used to operate a display controller, or microprocessor system comprising a data processor causes in conjunction with said data processor said controller or system to carry out the steps of the methods of the technology described herein. Such a computer software carrier could be a physical storage medium such as a ROM chip, CD-ROM, RAM, flash memory, or disk.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD-ROM, ROM, RAM, flash memory, or hard disk. It could also comprise a series of computer readable instructions transmittable to a computer system, via a modem or other interface device, over a tangible medium, including but not limited to optical or analogue communications lines. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic or optical. It is contemplated that such a computer program product may be distributed as a removable medium with accompanying printed or electronic documentation, for example, shrink-wrapped software, preloaded with a computer system, for example, on a system ROM or fixed disk, or distributed from a server or electronic bulletin board over a network, for example, the Internet or World Wide Web.

The foregoing detailed description has been presented for the purposes of illustration and description. It is not intended to be exhaustive or to limit the invention to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method for generating image data at a data processing system comprising:
determining, at a first data processor unit, that an image comprising one or more inactive pixels is required to be displayed to meet one or more desired properties of the displayed image;
providing first control data configured to cause the first or a further processor unit to generate image data which when displayed comprises the one or more inactive pixels.

2. The method of claim 1 comprising:
generating, responsive to the control data, image data which, when displayed, comprises the one or more inactive pixels to meet one or more desired properties of the displayed image.

3. The method of claim 2, where generating the image data for display comprises:
obtaining, from storage, previously generated image data which when displayed comprises a plurality of active pixels;
modifying, at the first or further processor unit, the previously generated image data to generate image data which when displayed comprises the one or more active pixels and further comprises the one or more inactive pixels to meet the one or more desired properties of the displayed image.

4. The method of claim 1, where generating the image data for display comprises:
rendering, at the first or further processor unit, the image data for display responsive to the control data,
wherein generating the image data for display comprises:
receiving, from a remote entity, a stream of encoded image data;
decoding the encoded image data;
processing the decoded data responsive to one or more instructions from the remote device to provide the image data for display, or
wherein processing the decoded data comprises:
modifying the decoded data, such that when displayed, the decoded data comprises the one or more inactive pixels to meet the one or more desired properties of the displayed image.

5. The method of claim 1, where determining that an image comprising one or more inactive pixels is required to be displayed comprises one or more of:
receiving an indication from a data processor unit of the data processor system that the image is to be displayed; and receiving instruction data from a remote entity, or
wherein receiving the indication from the data processor unit comprises:
receiving sensor data from an environment in which a display on which the image is to be displayed is located;
processing, at the first or a further processor unit, the sensor data to determine whether one more inactive pixels are required to meet one or more desired properties of the displayed image.

6. The method of claim 1, where the image to be displayed comprises a plurality of sub-portions, the method comprising:
providing inactive pixels in one or more of the sub-portions of the image to be displayed to meet one or more desired properties of the displayed image,
wherein the inactive pixels provided in a first sub-portion of the displayed image are to control one or more first properties of the first sub-portion, or
wherein inactive pixels in a second sub-portion of the displayed image are to control one or more second properties of the second sub-portion.

7. The method of claim 1, where providing the inactive pixels comprises providing the inactive pixels in the image to be displayed in a pattern, or
wherein a pattern of the inactive pixels in the first sub-portion is different to a pattern of the inactive pixels in the second sub-portion.

8. The method of claim 1, where the image data comprises one or more frames to be displayed.

9. The method of claims 2 further comprising:
storing the generated image data for display;
obtaining, by a display controller, the stored image data for display;
controlling, by the display controller, the display of the image data at a display, or
where the display comprises a digital screen or a surface of a substrate.

10. The method of any of claim 8, where controlling the display of the image data comprises:
controlling the properties of one or more pixels in an array on the digital screen or the surface of the substrate to display the image responsive to the image data.

11. The method of claim 1 further comprising:
generating, with a sensor, sensor data corresponding to a position on the display at which a user's gaze is fixed;
generating, responsive to the sensor data, the first control data.

12. The method of claim 6, where the image data comprises one or more image frames for display, the method comprising:
providing a pattern of inactive pixels in a first frame;
providing a further pattern of inactive pixels in a second frame.

13. The method of claim 6, where the image data comprises one or more image frames for display the method comprising:
providing a pattern of inactive pixels in the first frame when a first frame is displayed;
replacing the pattern of inactive pixels with a further pattern of inactive pixels during the time that the first frame is displayed.

14. The method of claim 1, further comprising:
performing one or more mitigation techniques to mitigate a visual effect in the displayed image responsive to the inactive pixels, or
wherein performing one or more mitigation techniques comprises:
setting one or more properties of a first active pixel in the image data to take account of one or more properties of the one or more inactive pixels.

15. The method of claim 1, where setting one or more properties of the first active pixels in the image comprises:
adjusting one or more colour values of the first active pixel.

16. The method of claim 15, where adjusting one or more colour values of the first active pixel comprises:
adjusting one or more colour values of the first active pixel based on colour values associated with one or more spatially related pixels that are inactive in the generated image data.

17. The method of claim 1, where the one or more desired properties of the image comprise at least one of: a desired resolution of the image and a desired brightness of the image.

18. A data processor system to provide image data for display, the data processor system operable to:
determine that an image comprising one or more inactive pixels is required to be displayed to meet one or more desired properties of the displayed image;
providing first control data to cause a processor unit to generate image data, which when displayed comprises the one or more inactive pixels.

19. The data processor system of claim 18, where the data processor system comprises one of: a host processor; a graphics processor unit; a display controller unit, an image signal processor unit, video processor unit neural processor unit and a display.

20. A computer readable storage medium storing computer software code which when executing on a processor performs the method of claim 1.
